(19) United States
(12) Patent Application Publication
(10) Pub. No.: US 2017/0149586 A1
(43) Pub. Date: May 25, 2017

(54) GATEWAY DEVICE

(71) Applicant: Kabushiki Kaisha Toshiba, Minato-ku, Tokyo (JP)

(72) Inventor: Shinji TAKAHASHI, Kokubunji Tokyo (JP)

(21) Appl. No.: 15/039,382

(22) PCT Filed: Mar. 30, 2015
(86) PCT No.: PCT/JP2015/059912

§ 371 Date: May 25, 2016

(30) Foreign Application Priority Data
May 9, 2014 (JP) 2014-097936

(51) Int. Cl. H04L 12/66; H04L 12/801; H04L 12/861

(52) U.S. Cl. CPC H04L 12/66; H04L 49/9005; H04L 47/16

(57) ABSTRACT

According to one embodiment, a gateway device includes a buffer memory, a conversion table, a first controller, a second controller, and a third controller. The buffer memory temporarily stores therein first-type data transmitted in the first network and second-type data transmitted in the second network. The conversion table registers therein conversion information to perform mutual format conversion with respect to the first-type data and the second-type data. The first controller is configured to generate, based on the conversion information, the first-type data from the second-type data stored in the buffer memory. The second controller is configured to generate, based on the conversion information, the second-type data from the first-type data stored in the buffer memory. The third controller is configured to read the conversion information from the conversion table and to notify the first controller and the second controller about the read conversion information.

### FIELD

Embodiments of the present invention relate to a gateway device.

### BACKGROUND

Conventionally, there has been known a relaying device (a gateway device) that performs relaying between, two mutually different networks. The relaying device has the function of transferring data transmitted in one network to the other network, and vice versa.

### CITATION LIST

### Patent Literature

Patent Literature 1: Japanese Patent Publication Laid-open No. 2005-94289

### SUMMARY OF THE INVENTION

### Problem to be Solved by the Invention

In the configuration mentioned above, sometimes the data transmitted in one network has a different data format than the format of the data transmitted in the other network. In that case, for example, if the data transmitted in one network is transferred without modification to the other network, then the data not required in the other network may also get transferred, thereby leading to a decline in the data transmission efficiency.

### Means for Solving Problem

A gateway device according to an embodiment is configured to perform relaying between a first network and a second network in which cyclic transmission is performed. The gateway device comprises a buffer memory, a conversion table, a first controller, a second controller, and a third controller. The buffer memory temporarily stores therein first-type data transmitted in the first network and second-type data transmitted in the second network. The conversion table registers therein conversion information to perform mutual format conversion with respect to the first-type data and the second-type data. The first controller is configured to generate, based on the conversion, information, the first-type data from the second-type data stored in the buffer memory. The second controller is configured to generate, based on the conversion information, the second-type data from the first-type data stored in the buffet memory. The third controller is configured to read the conversion information from the conversion table and to notify the first controller and the second controller about the read conversion information.

### BRIEF DESCRIPTION OF DRAWINGS

FIG. 1 is an exemplary block diagram illustrating one example of a configuration of a gateway device according to an embodiment.

FIG. 2 is an exemplary diagram illustrating one example of a first conversion table according to the embodiment.

FIG. 3A is an exemplary diagram illustrating one example of a data structure of first-type data that is joined by the gateway device according to the embodiment.

FIG. 3B is an exemplary diagram illustrating one example of a data structure of first-type data that is joined by the gateway device according to the embodiment.

FIG. 4 is an exemplary diagram illustrating one example of a manner in which the first-type data illustrated in FIG. 3A and FIG. 3B is stored in a buffer memory according to the embodiment.

FIG. 5 is an exemplary diagram illustrating one example of a data structure of second-type data that is generated by the gateway device according to the embodiment based on the first-type data illustrated in FIG. 3A and FIG. 3B.

FIG. 6 is an exemplary diagram illustrating one example of a second conversion table according to the embodiment.

FIG. 7 is an exemplary diagram illustrating one example of a data structure of second-type data that is divided by the gateway device according to the embodiment.

FIG. 8 is an exemplary diagram illustrating one example of a manner in which the second-type data illustrated in FIG. 7 is stored in the buffer memory according to the embodiment.

FIG. 9A is an exemplary diagram illustrating one example of a data structure of first-type data that is generated by the gateway device according to the embodiment based on the second-type data illustrated in FIG. 7.

FIG. 9B is an exemplary diagram illustrating one example of a data structure of first-type data that is generated by the gateway device according to the embodiment based on the second-type data illustrated in FIG. 7.

FIG. 10 is an exemplary sequence diagram to explain one example of operation performed by a first controller, a second controller, and a third controller in the case of performing a joining operation by the gateway device according to the embodiment

FIG. 11 is an exemplary sequence diagram to explain one example of operation performed by the first controller, the second controller, and the third controller in the case of performing a dividing operation by the gateway device according to the embodiment.

FIG. 12 is an exemplary diagram illustrating one example of a first conversion table according to a modification.

FIG. 13A is an exemplary diagram illustrating one example of a data structure of first-type data that is joined by the gateway device according to the modification.

FIG. 13B is an exemplary diagram illustrating one example of a data structure of first-type data that is joined by the gateway device according to the modification.

FIG. 14 is an exemplary diagram illustrating one example of, a manner in which the first-type data illustrated in FIG. 13A and FIG. 13B is stored in the buffer memory according to the modification.

FIG. 15 is an exemplary diagram illustrating one example of a data structure of second-type data that is generated by the gateway device according to the modification based on the first-type data illustrated in FIG. 13A and FIG. 13B.

FIG. 16 is an exemplary diagram illustrating one example of a second conversion table according to the modification.

### DETAILED DESCRIPTION

An embodiment is described below with reference to the accompanying drawings.

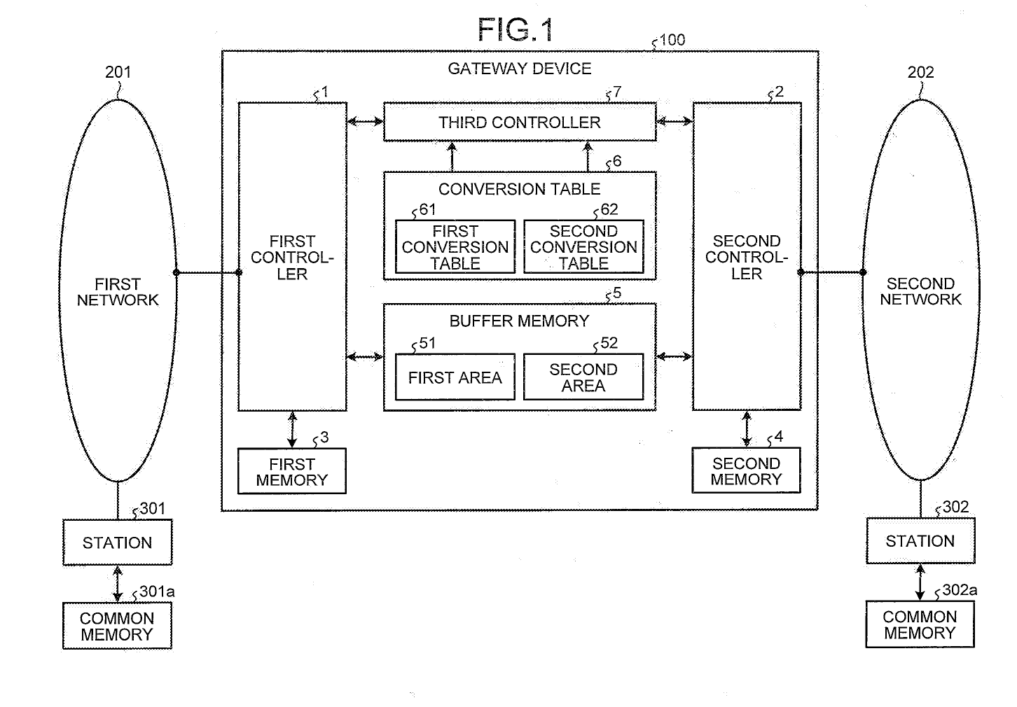

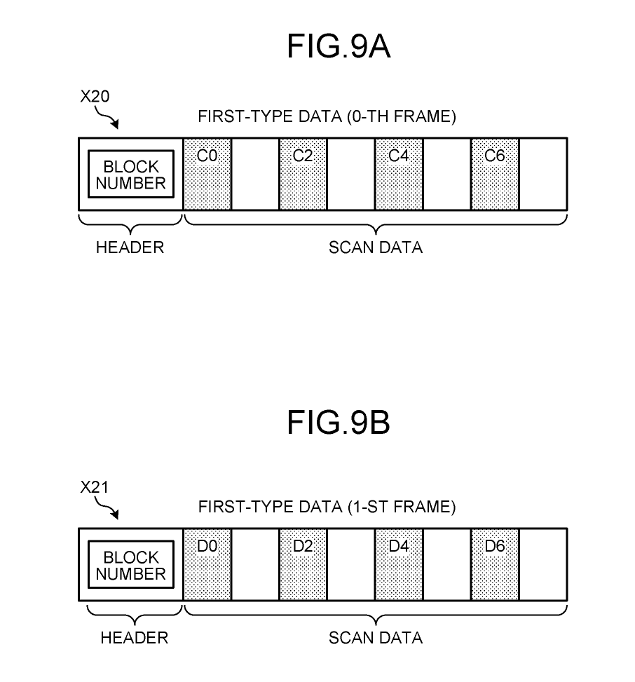

Firstly, explained with reference to FIG. 1 to FIG. 8, FIG. 9A, and FIG. 9B is one example of a configuration of a gateway device 100 according to the embodiment.

As illustrated in FIG. 1, the gateway device 100 is provided to perform relaying between two mutually different networks (a first network 201 and a second network 202). Stations 301 and 302, which are comprised in a monitoring-control system to monitor and control a variety of plant equipment, are connected to the first network 201 and the second network 202, respectively.

The stations 301 and 302 include common memories 301a and 302a, respectively, and are configured to perform cyclic transmission (scan transmission) with other stations (not illustrated connected to the first network 201 and the second network 202. The common memories 301a and 302a store therein common data that is updated at regular intervals. The common data represents a group of control data (scan data) that is sent/received by cyclic transmission among the stations on the first network 201 and the second network 202.

Herein, cyclic transmission represents a data transmission method in which a plurality'of stations provided on TCnet-compatible networks send scan data to and receive scan data from each other at regular intervals such that all of the stations have the common data of the same content. Herein, TCnet is one example of a real-time, communication protocol used in cyclic transmission and represents a network technology to implement the abovementioned communication function in Ethernet™.

As illustrated in FIG. 1, the gateway device 100 includes a first controller 1, a second controller 2, a first memory 3, a second memory 4, and a buffer memory 5. Moreover, the buffer memory 5 includes a first area 51 and a second area 52. Meanwhile, although not illustrated in FIG. 1, the gateway device 100 also includes a CPU (central processing unit) that comprehensively controls each component mentioned above.

The first controller 1 represents a module that controls communication between the gateway device 100 and the first network 201. For example, the first controller 1 is configured to store first-type data received from the first network 201 (i.e., scan data transmitted in the first network) in the first memory 3 and in the buffer memory 5 (the first area 51), and to send the data stored in the first memory 3 or the buffer memory 5 as first-type data to the first network 201. Meanwhile, as described later, in the header portion of the first-type data, a block number is specified that indicates the number of the frame to which the concerned first-type data belongs.

Similarly, the second controller 2 represents a module that controls communication between the gateway device 100 and the second network 202. For example, the second controller 2 is configured to store second-type data received from the second network 202 (i.e., scan data transmitted in the second network) in the second memory 4 and in the buffer memory 5 (the second area 52), and to send the data stored in the first memory 3 or the buffer memory 5 as second-type data to the second network 202. Meanwhile, in an identical manner to the first-type data, in the header portion of the second-type data too, a block number is specified that indicates the number of the frame to which the concerned second-type data belongs.

Since the first network 201 and the second network 202 that are connected to the gateway device 100 are mutually different networks, first-type data transmitted in the first network 201 may have a different data format than second-type data transmitted in the second network 202. Hence, in the case of sending first-type data to the second network 202 or in the case of sending second-type data to the first network 201, sometimes it is necessary to perform mutual format conversion with respect to the first-type data and the second-type data.

In that regard, the gateway device 100 according to the embodiment comprises a conversion table 6 that registers therein conversion information to perform mutual format conversion with respect to the first-type data and the second-type data. Moreover, the gateway device 100 comprises a third controller 7 that reads the conversion information registered in the conversion table 6, and notifies the first controller 1 and the second controller 2 about the read conversion information.

The third controller 7 is implemented using hardware such as FPGA (Field Programmable Gate Array). With that, unlike in the case in which the conversion information is read using software by a CPU (not illustrated) that comprehensively controls the constituent elements of the gateway device 100, the conversion information can be read using separate hardware other than the CPU. As a result, the resources of the CPU are not spent in reading the conversion information, thereby enabling achieving reduction in the processing load of the CPU.

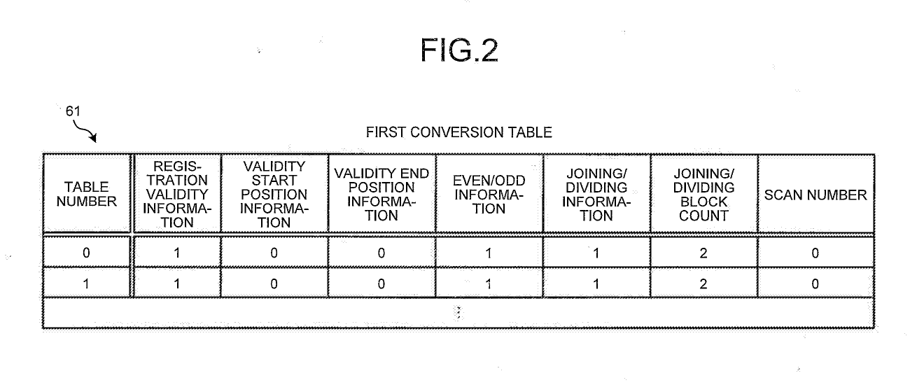

The conversion table 6 includes a first conversion table 61 (see FIG. 2), which is referred to in the case of performing format conversion with respect to the first-type data, and a second conversion table 62, which is referred to in the case of performing format conversion (a dividing operation (described later)). Regarding the conversion information registered in the first conversion table 61 and the conversion information registered in the second conversion table 62, the details are given later.

Examples of the method of performing format conversion include a joining operation and a dividing operation. In the joining operation, the data of a plurality of frames is joined to generate new data of a single frame. In the dividing operation, the data of a single frame is divided to generate data of a plurality of frames. Given below is the specific explanation of the joining operation and the dividing operation according to the embodiment.

(Joining Operation According to Embodiment)

In the embodiment, the second controller 2 is configured to join valid data that is included in the first-type data of two successive frames, so that second-type data of a single frame is generated. Herein, valid data represents the data“obtained by removing, from the first-type data, invalid data not required in the second network 202.

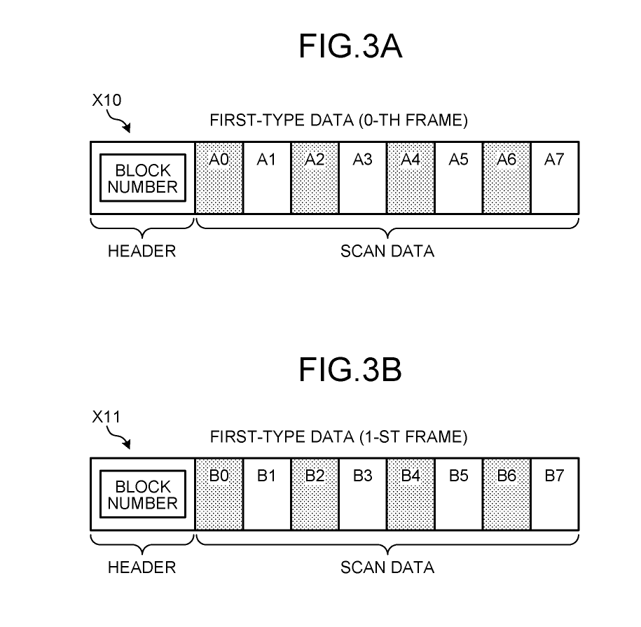

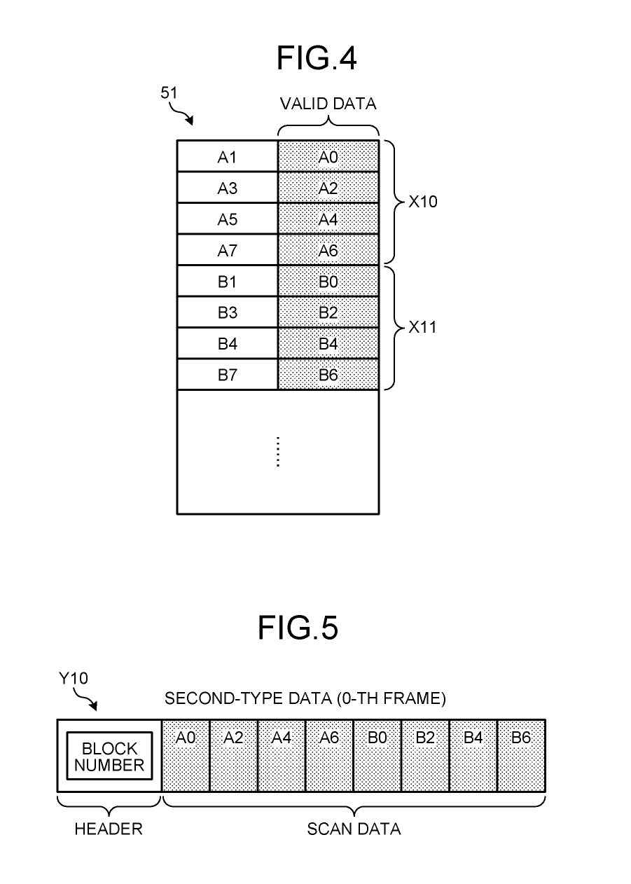

For example, the second controller 2 is configured to generate, based on first-type data X10 and X11 of two frames as illustrated in FIG. 3A and FIG. 3B, second-type data Y10 of a single frame as illustrated in FIG. 5. The first-type data X10 represents data received in the 0-th frame from the first network 201, and the first-type data X11 represents data received in the 1-st frame from the first network 201. The first-type data X10 and X11 is temporarily stored in the buffer memory 5 (the first area 51) in the state illustrated in FIG. 4.

More particularly, the second controller 2 is configured to join only the valid data (see the dotted mesh portions illustrated in FIG. 4) from among the first-type data X10 and X11 stored in the first area 51, so that the second-type data Y10 is generated. As illustrated in the dotted mesh portions, in FIG. 3A, the valid data in the first-type data X10 is put at the bit positions corresponding to the even-numbered bits of the first-type data X10. Similarly, as illustrated in the dotted mesh portions in FIG. 3B, the valid data in the first-type data X11 is put at the bit positions corresponding to the even-numbered bits of the first-type data X11.

The second controller 2 is configured to send the second-type data Y10, which is generated as described above, as data in the 0-th frame to the second network 202.

The joining operation as described above is performed based on the first conversion table 61 illustrated in FIG. 2. In the first conversion table 61, table number, registration validity information, validity start position information, validity end position information, even/odd information, joining/dividing information, joining/dividing block count, and scan number are stored as the conversion information and in a mutually corresponding manner.

The table number illustrated in FIG. 2 corresponds to the block number specified in the header portion of first-type data received from the first network 201. When first-type data is received from the first network 201, the third controller 7 is configured: to read, from the first conversion table 61, conversion information registered in the row having the table number corresponding to the block number specified in the concerned first-type data; and to notify the second controller 2 about the read conversion information. For example, since the first-type data X10 illustrated in FIG. 3A is received in the 0-th frame, the first-type data X10 has “0” set in the block number. Thus, the third controller 7 reads, from the first conversion table 61, conversion information of the row in which the table number “0” is specified, and the third controller 7 notifies the second controller 2 about the read conversion information. Similarly, when the first-type data X11 illustrated in FIG. 3B is received, the third controller 7 reads, from the first conversion table 61, conversion information of the row in which the table number “1” is specified,' and the third controller 7 notifies the second controller 2 about the read conversion information.

The validity start position information, the validity end position information, and the even/odd information represents information indicating such bit positions in first-type data, which contains the block number specified in, the table number, at, which the valid data is put.

More particularly, the validity start position information represents information indicating the bit position that serves as the start point of the valid data. Moreover, the validity end position information represents information indicating the bit position that, serves as the end point of the valid data. If the validity start position information as well as the validity end position information has “0” set therein, then neither the validity start position information nor the validity end position information is taken into account while determining the bit positions of the valid data. Regarding a case in which the validity start position, information as well as the validity end position information is set to a value other than “0” so that the positioning of valid, data is identified using the validity start position information and the validity end position information, the explanation is given later in a modification.

The even/odd information represents information. indicating whether the valid data is put at the bit positions corresponding to the even-numbered bits of the first-type data or at the bit positions corresponding to the odd-numbered, bits of the first-type data. When the even/odd information has “1” set therein, it is determined that the valid data is put at the bit positions corresponding to the even-numbered bits of the valid data. On the other hand, when the even/odd information has “2” set therein, it is determined that the valid data is put at the bit positions corresponding to the odd-numbered bits of the valid data. Meanwhile, when the even/odd information has “0” set therein, the even/odd information is not taken into account while determining the bit positions of the valid data.

The registration validity information represents information indicating whether or not format conversion of first-type data is required in the case of sending the first-type data received from the first network 201 as second-type data to the second network 202. Based on the registration validity information, the second controller 2 determines whether or not to perform the format conversion. The second controller 2 determines to perform the format conversion when it is confirmed that the registration validity information has “1” set therein, and the second controller 2 determines not to perform the format conversion when it is confirmed that the registration validity information has “0” set therein. Meanwhile, when it is determined not to perform the format conversion, the second controller 2 sends the first-type data, which is received from the first network 201, without modification as second-type data to the second network 202.

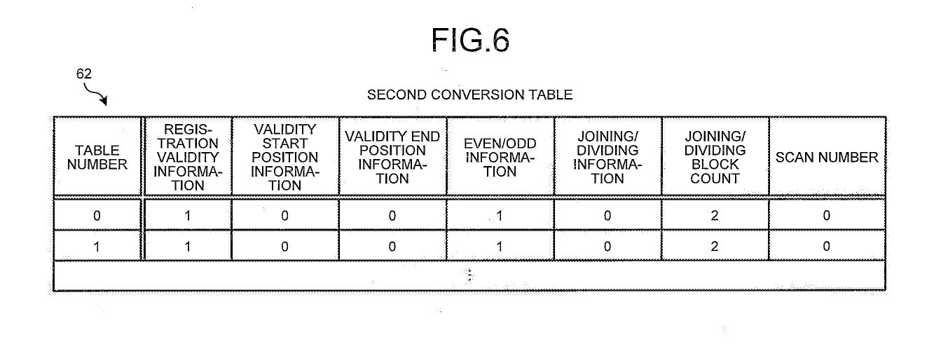

The joining/dividing information illustrated in FIG. 2 represents information indicating that the method of format conversion performed with respect to the first-type data represents a joining operation. Unlike the second conversion table 62 (see FIG. 6) (described later), in the first conversion table 61 illustrated in FIG. 2, the joining/dividing information has “1” set therein.

The joining/dividing block count illustrated in FIG. 2 represents information indicating the number of frames to which belongs the first-type data required in generating second-type data of a single frame. In the first conversion table 61 illustrated in FIG. 2, the joining/dividing block count, has “2” set therein. Thus, by referring to the first conversion table 61, it is understood that first-type data of two frames (for example, the first-type data X10 and X11 illustrated in FIG. 3A and FIG. 3B) is required to generate second-type data of a single frame (for example, the second-type data Y10 illustrated in FIG. 5).

The scan number illustrated in FIG. 2 represents information indicating about the number of the frame to which belongs the second-type data generated based on the first-type data having the block number, specified in the table number. Thus, by referring to the first conversion table illustrated in FIG. 2, it is understood that, based on first data having the block number “0” (for example, the first-type data X10 illustrated in FIG. 3A) and first data having the block number “1” (for example, the first-type data X11 illustrated in FIG. 3B), second-type data in the 0-th frame (for example, the second-type data Y10 illustrated in FIG. 5) is generated.

(Dividing Operation According to Embodiment)

In the embodiment, the first controller 1 is configured to add predetermined additional data to each of two sets of divided data based on second-type data of single frame, so that first-type data of two successive frames is generated. Herein, the divided data represents data that is configured by dividing second-type data of a single frame into two sets of data.

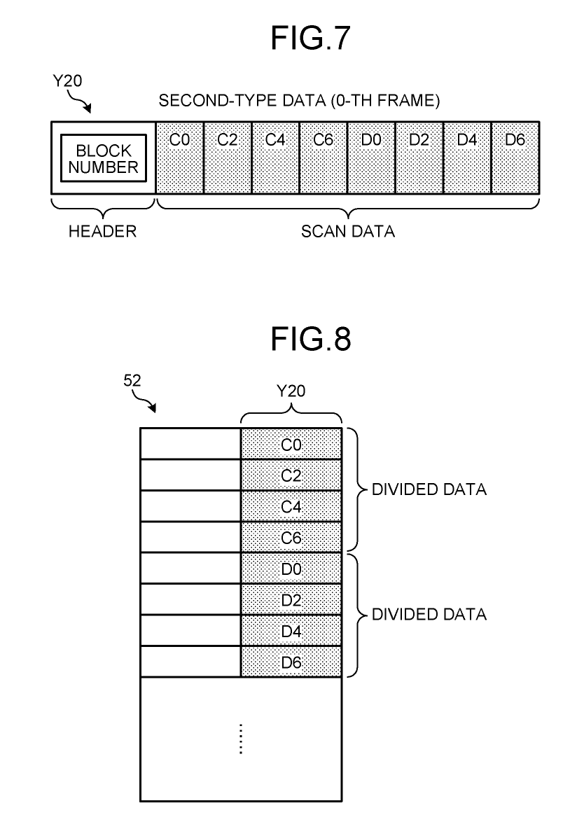

For example, the first controller 1 is configured to generate, based on second-type data Y20 of a single frame as illustrated in FIG. 7, first-type data X20 and X21 illustrated in FIG. 9A and FIG. 9B. The second-type data Y20 is temporarily stored in the buffer memory 5 (the second area 52) in the state illustrated in FIG. 8.

More particularly, the first controller 1 is configured to add predetermined additional data to each of the two sets of divided data (see FIG. 8) that are configured by dividing the second-type data Y20 stored in the second area 52, so that the first-type data X20 and X21 is generated. As illustrated in the dotted mesh portions in FIG. 9A and FIG. 9B, the divided data is put at the bit positions corresponding to the even-numbered bits of each of the first-type data X20 and X21. Moreover, as illustrated in blank portions sandwiched between the dotted mesh portions illustrated in FIG. 9A and FIG. 9B, the additional data is put at the bit positions corresponding to the odd-numbered bits of each, of the first-type data X20 and X21.

The first controller 1 is configured to sequentially send the first-type data X20 and X21 of two frames that are generated as described above for one frame at a time to the first network 201. More particularly, the first controller 1 is configured to send the first-type data X20 as the data of the 0-th frame to the first network 201, and to send the first-type data X21 as the data of the 1-st frame to the first network 201.

The dividing operation as described above is performed based on the second conversion table 62 illustrated in FIG. 6. In the second conversion table 62, similarly to the first conversion table (see FIG. 2), table number, registration validity information, validity start position information, validity end position information, even/odd information, joining/dividing information, joining/dividing block count, and scan number are registered, as the conversion information and in a mutually corresponding manner.

The table number illustrated, in FIG. 6 corresponds to the block number specified in the header portion of second-type data received from the second network 202. When second-type data is received from the second network 202, the third controller 7 is configured: to read, from the second conversion table 62, conversion information registered in the row having the table number that corresponds to the block, number specified in the second first-type data; and to notify the first controller 1 about the read conversion information. For example, since the second-type data Y20 illustrated in FIG. 7 is received in the 0-th frame, the second-type data Y20 has “0” set in the block number. Thus, when the second-type data Y20 is received, the third controller 7 reads, from the second conversion table 62, the conversion information having the row in which the table number “0” is specified, and the third controller 7 notifies the first controller 1 about the read conversion information.

The validity start position information, the validity end position information, and the even/odd information illustrated in FIG. 6 represents information that indicates, when first-type data is generated by adding additional information to each of a plurality of sets of divided data formed based on second-type data, the bit positions of each set of divided data in the first-type data.

More particularly, the validity start position information represents information indicating the bit position that serves as the start point for putting the divided data. Moreover, the validity end position information represents information indicating the bit position that serves as the end point for putting the divided data. Similarly to the case of the first conversion table 61 (see FIG. 2), if the validity start position information in the second conversion table 62 as well as the validity end position information in the second conversion table 62 has “0” set therein, then neither the validity start position information nor the validity end position information are taken into account while determining the bit positions of the divided data.

The even/odd information represents information indicating whether-the divided data is put at the bit positions corresponding to the even-numbered bits of the first-type data or at the bit positions corresponding to the odd-numbered bits of the first-type data. When the even/odd information has “1” set therein, the first controller 1 determines to put the divided data at the bit positions corresponding to the even-numbered bits. On the other hand, when the even/odd information has “2” set therein, the first controller 1 determines to put the divided data at the bit positions corresponding to the odd-numbered bits. Meanwhile, similarly to the case of the first conversion table 61 (see FIG. 2), when the even/odd information in the second conversion table 62 has “0” set therein, the even/odd information is not taken into account while determining the bit positions of the divided data.

The registration validity information illustrated in FIG. 6 represents information indicating whether or not format conversion of second-type data is required in the case of sending the second-type data received from the second network 202 as first-type data to the first network 201. Based on the registration validity information, the first controller 1 determines whether or not to perform the format conversion. Similarly to the case of the first conversion table 61 (see FIG. 2), the first controller 1 determines to perform the format conversion when it is confirmed that the registration validity information has “1” set therein, and the first controller 1 determines not to perform the format conversion when it is confirmed that the registration validity information has “0” set therein.

The joining/dividing information illustrated in FIG. 6 represents information indicating that the method of format conversion performed with respect to the second-type data represents a dividing operation. Unlike the first conversion table 61 described earlier (see FIG. 2), in the second conversion table 62 illustrated in FIG. 6, the joining/dividing information has “0” set therein.

The joining/dividing block count illustrated in FIG. 6 represents information indicating the number of sets of divided data obtainable from second-type data of a single frame, that is, represents information indicating the number of frames to which belongs first-type data that can be generated based on second-type data of a single frame. In the second conversion table 62 illustrated in FIG. 6, the joining/dividing block count has “2” set therein. Thus, by referring to the second conversion table 62, it is understood that, based on second-type data of a single frame (for example, the second-type data Y20 illustrated in FIG. 7), two sets of divided data are generated and first-type data of two frames (for example, the first-type data X20 and X21 illustrated in FIG. 9A and FIG. 9B) is generated.

The scan number illustrated in FIG. 6 corresponds to the block number of the second-type data serving as the basis for generating divided data. The second-type data having the block number specified in the scan number is divided into sets of divided data equal in number to the number specified in the joining/dividing block count and, based on the divided data, first-type data is generated that has the block number specified in the table number. In the second conversion table 62 illustrated in FIG. 6, in the rows having the table number “0” and “1”, the scan, number is set to “0”. Hence, by referring to the second conversion table 62 illustrated in FIG. 6, it is understood that, based on the second-type data having the block number “0” (for example, the second-type data Y20 illustrated in FIG. 7), the first-type data having the block number “0” (for example, the first-type data X20 illustrated in FIG. 9A) and the first-type data X21 having the block number “1” (for example, the first-type data X21 illustrated in FIG. 9B) is generated.

Explained below with reference to FIG. 2 to FIG. 5 and FIG. 10 is one example of operation sequence performed by the first controller 1, the second controller 2, and the third controller 7 in the case of performing a joining operation in the gateway device 100 according to the embodiment. The following explanation is given for an example in which the second-type data Y10 of a single frame (see FIG. 5) is generated based on the first-type data X10 and X11 of two successive frames (see FIG. 3).

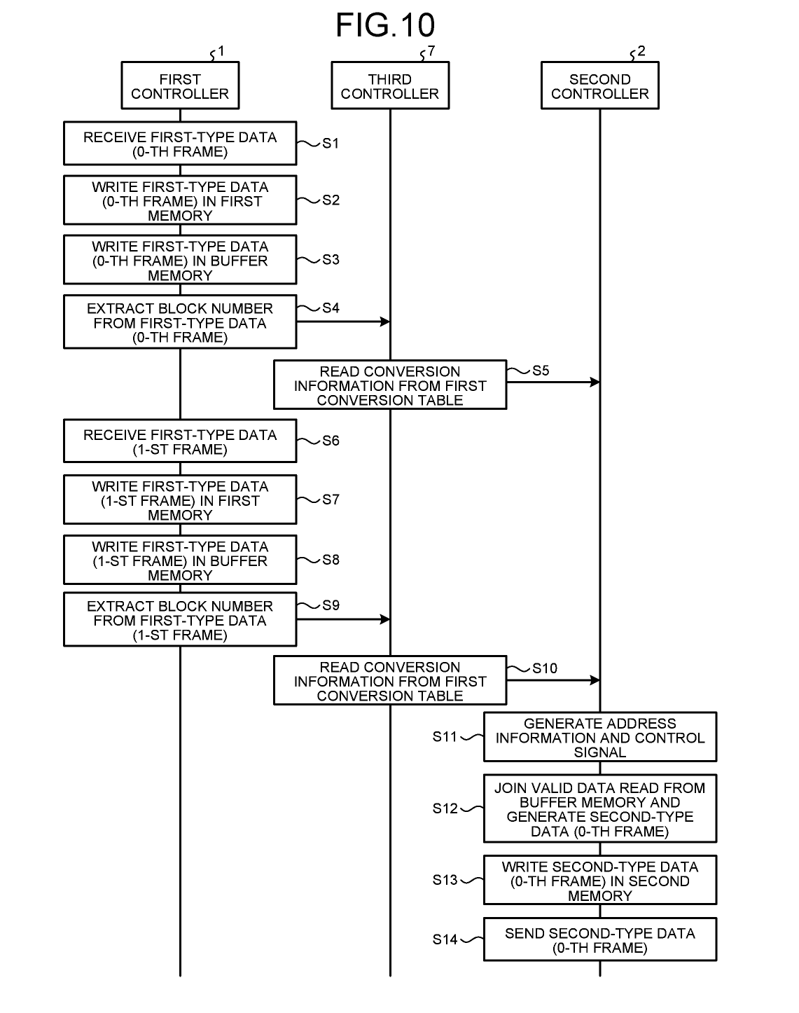

In this operation sequence, as illustrated in FIG. 10, firstly, at Step S1, the first controller 1 receives the first-type data X10 in the 0-th frame (see FIG. 3A) from the first network 201.

Then, at Step S2, the first controller 1 writes the first-type data X10, which is received at Step S1, in the first memory 3.

Subsequently, at Step S3, the first controller 1 writes the first-type data X10, which is received at Step S1, in the buffer memory 5 (the first area 51).

Then, at Step S4, the first controller 1 extracts the block number from the header portion of the first-type data X10 received at Step S1, and notifies the third controller 7 about the extracted block number. As described earlier, the block number represents information indicating the number of the frame to which the data belongs. Thus, the first-type data X10 has “0” set in the block number.

Subsequently, at Step S5, based on the block, number notified from the first controller 1, the third controller 7 reads conversion information from the first conversion table 61 (see FIG. 2) and notifies the second controller 2 about the read conversion information. Herein, since it is assumed that the block number “0” is notified from the first controller 1, the third controller 7 reads, from the first conversion table 61, the conversion information registered in the row having the table number “0” and notifies the second controller 2 about the read conversion information.

In the first conversion table 61 illustrated in FIG. 2, in the row having the table number “0”, the registration validity information has “1” set therein, the validity start position information and the validity end position information has “0” set therein, the even/odd information has “1” set therein, the joining/dividing information has “1” set therein, the joining/dividing block count has “2” set therein, and the scan number has “0” set therein. Since the joining/dividing information has “1” set therein and the joining/dividing block count has “2” set therein, the second controller 2 determines to perform a joining operation with respect to: the first-type data X10; and the first-type data X11 (see FIG. 3B) that is in the next frame of the first-type data X10 (i.e., in the 1-st frame). Herein, since the conversion information corresponding to the first-type data X11 is not yet notified from the third controller 7, the second controller 2 waits until the conversion information corresponding to the first-type data X11 is notified from the third controller 7 (i.e., until the operation at Step S10 (described later) is performed).

Then, at Step S6, the first controller 1 receives the first-type data X11 in the first frame (see FIG. 3B).

Subsequently, at Step S7, the first controller 1 writes the first-type data X11, which is received at Step S6, in the first memory 3.

Then, at Step S8, the first controller 1 writes the first-type data X11, which is received at Step S6, in the buffer memory 5 (the first area 51). As a result, the first-type data X10 and X11 of two successive frames gets stored in the first area 51 in the state illustrated in FIG. 4.

Then, at Step S9, the first controller 1 extracts the block number from the header of the first-type data X11 received at Step S6, and notifies the third controller 7 about the extracted block number. As described above, since the first-type data X11 represents data in the first frame, the first controller 1 notifies the third controller 7 about the fact that the first-type data X11 has the block number “1”.

Subsequently, at Step S10, based on the block number notified from the first controller 1, the third controller 7 reads the conversion information from the first conversion table 61 (see FIG. 2) and notifies the second controller 2 about the read conversion information. That is, the first controller 1 notifies the second controller 2 about the conversion information registered in the row having the table number “1” in the first conversion table 61. In the first conversion table 61 illustrated in FIG. 2, in the row having the table number “1”; the registration validity information has “1” set therein, the validity start position information and the validity end position information has “0” set therein, the even/odd information has “1” set therein, the joining/dividing information has “1” set therein, the joining/dividing block count has “2” set therein, and the scan number has “0” set therein.

As a result of performing the operations explained above, the second controller 2 obtains the first-type data. X10 and X11 of two frames that is required in generating the second-type data Y10 of a single frame (see FIG. 5). Then, at Step S11, based on the conversion information obtained from the third controller 7, the second controller 2 generates address information and a control signal to access the buffer memory 5 (the first area 51) The address information represents information indicating addresses in the first area 51 in which the valid data of the first-type data X10 and the valid data of the first-type address X11 is stored (see the dotted mesh portions in FIG. 3A and FIG. 3B). The control signal represents a signal used in reading the valid data from the first area 51.

In the first conversion table 61 illustrated in FIG. 2, as described earlier, in the row having the table number “0” and the row having the table number “1”, the validity start position information and the validity end position information has “0” set therein and the even/odd information has “1” set therein. Thus, the address information generated at Step S11 represents the address of such portions in the first area 51 in which the valid data put at the even-numbered bits of the first-type data X10 and X11 is stored (see the dotted mesh portions in FIG. 3A, FIG. 3B, and FIG. 4).

Then, at Step S12, the second controller 2 reads the valid data from the buffer memory 5 (the first area 51) by use of the address information and the control signal generated at Step S11, and joins the read valid data to generate the second-type data Y10 of a single frame.

Subsequently, at Step S13, the second controller 2 writes the second-type data Y10, which is generated at Step S13, in the second memory 4.

Then, at Step S14, the second controller 2 sends, to the second network 202, the second-type data Y10 of a single frame as generated at Step S13. As described earlier, in the first conversion table 61 illustrated in FIG. 2, in the row having the table number “0” and the row having the table number “1”, the scan number has “0” set therein. Hence, the second controller 2 sends the second-type data Y10 as data in the 0-th frame to the second network 202.

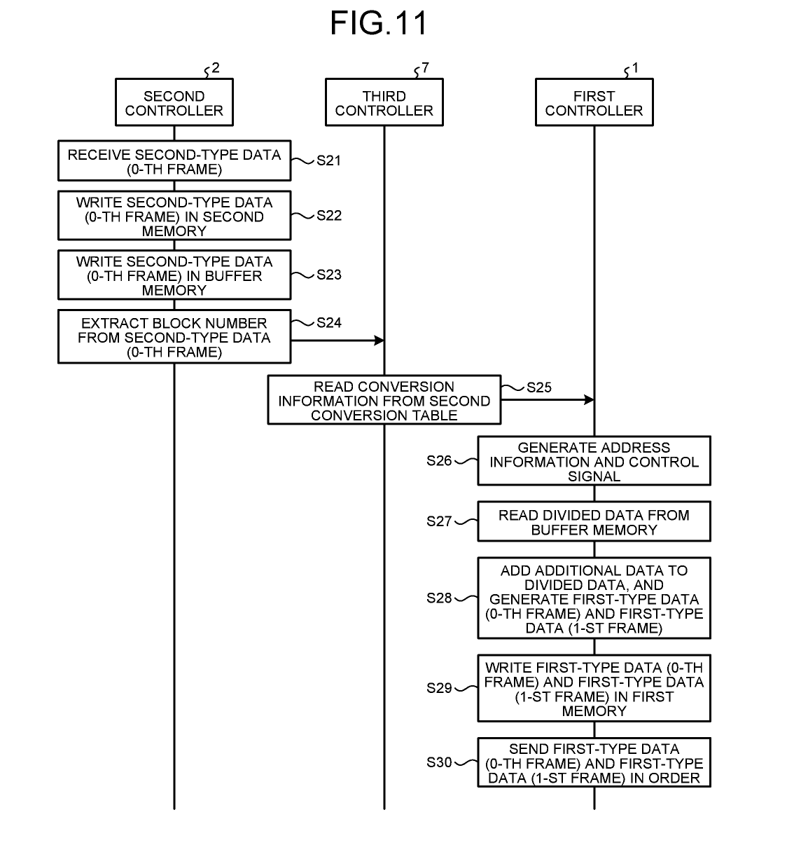

Explained below with reference to FIG. 6 to FIG. 8, FIG. 9A, FIG. 9B, and FIG. 11 is one example of operation sequence performed by the first controller 1, the second controller 2, and the third controller 7 in the case of performing a dividing operation in the gateway device 100 according to the embodiment. The following explanation is given for an example in which the first-type data X20 and X21 of two successive frames (see FIG. 9A and FIG. 9B) are generated based on the second-type data Y20 of a single frame (see FIG. 7).

In this operation sequence, as illustrated in FIG. 11, firstly, at Step S21, the second controller 2 receives the second-type data Y20 in the 0-th frame (see FIG. 7) from the second network 202.

Then, at Step S22, the second controller 2 writes the second-type data Y20, which is received at Step S21, in the second memory 4.

Subsequently, at Step S23, the second controller 2 writes the second-type data Y20, which is received, at Step S21, in the buffer memory 5 (the second area 52). As a result, the second-type data Y20 is stored in the second area 52 in the state illustrated in FIG. 8.

Then, at Step S24, the second controller 2 extracts the-block number from the header portion of the second-type data Y20 at Step S21, and notifies the third controller 7 about the extracted block number. As described earlier, since the second-type data Y20 represents data in the 0-th frame, the second controller 2 notifies the third controller 7 about the fact that the second-type data X20 has the block number “0”.

Subsequently, at Step S25, based on the block number notified from the second controller 2, the third controller 7 reads conversion information from the second conversion table 62 (see FIG. 6) and notifies the second controller 2 about the read conversion information. Herein, since it is assumed that the block number “0” is notified from the second controller 2, the third controller 7 firstly reads the conversion information registered in the row having the table, number “0” in the second conversion table 62.

In the second conversion table 62 illustrated in FIG. 6, in the row having the table number “0”, the registration validity information has “1” set, therein, the validity start position information and the validity end position information has “0” set therein, the even/odd information has “1” set therein, the joining/dividing information has “0” set therein, the joining/dividing block count has “2” set therein, and the scan number has “0” set therein. Since the joining/dividing information has “0” set therein, it is understood that a dividing operation is performed with respect to the second-type data Y20. Therefore, the third controller 7 searches the second conversion table 62 for the rows having the scan number “0” and notifies the first controller 1 about the conversion information of all rows having the scan number “0”.

In the second conversion table 62 illustrated in FIG. 6, since the row having the table number “1” also has the scan number set to “0; the third controller 7 reads the conversion information registered in the row having the table number “0”' as well as the row having the table number “1” in the second conversion table 62, and notifies the first controller 1 about the read conversion information. Meanwhile, in the second conversion table 62 illustrated in FIG. 6, in the row having the table number “1”, the registration validity information has “1” set therein, the validity start position information and the validity end position information has “0” set therein, the even/odd information has “1” set therein, the joining/dividing information has “0” set therein, the joining/dividing block count has “2” set therein, and the scan number has “0” set therein.

As a result of performing the operations, described above, based on the conversion information notified from the third controller 7, the first controller 1 determines to perform a dividing operation with respect to the second-type data Y20. More particularly, the first controller 1 divides the second-type data Y20 into two sets of data to generate the first-type data X20 and X21 of two successive frames (see FIG. 9A and FIG. 9B). Then, at Step S26, based on the conversion information obtained from the third controller 7, the first controller 1 generates address information and a control signal to access the buffer memory 5 (the second area 52). The address information represents information indicating addresses in the second area 52 in which the second-type data Y20 is stored (see the dotted mesh portions in FIG. 8), and the control signal represents a signal used in reading valid data from the second area 52.

Subsequently, at Step S27, the first controller 1 reads, from the buffer memory 5 (the second area 52), the two sets of divided data-based on the second-type data Y20 (see FIG. 8) by use of the address information and the control signal generated at Step S26. The divided data represents data, configured by dividing the second-type-data Y20.

Then, at Step S28, the first controller 1 adds predetermined additional data to each of-the two sets of divided data read at Step S27, so that the first-type data X20 and X21 of two successive frames is generated. As described earlier, in the second conversion table 62 illustrated in FIG. 6, in the row having the table number “0” and the row having the table number “1”, the validity start position information and the validity end position information has “0” set therein and the even/odd information has “1” set therein. Hence, at Step S28, the two sets of divided data are put at the positions corresponding to the even-numbered bits in the first-type data X20 and X21 (see the dotted mesh portions in FIG. 9A and FIG. 9B), and the additional data is put at the positions corresponding to the odd-numbered bits in the first-type data X20 and X21 (see the blank portions sandwiched between the dotted mesh portions in FIG. 9A and FIG. 9B).

Subsequently, at Step S29, the first controller 1 writes, in the first memory 3, the first-type data X20 and X21 of two frames as generated at Step S28.

Then, at Step S30, the first-type data X20 and X21 of two frames that are generated at Step S28, are sequentially sent to the first network 201. As described earlier, in the first conversion table 61 illustrated in FIG. 2, since the rows in which the scan number is set to “0” have the two table numbers “0” and “1”, the first controller 1 sends the first-type data X20 as data in the 0-th frame to the first network 201 and then sends the first-type data X21 as data in the 1-st frame to the first network 201.

As described above, the gateway device 100 according to the embodiment includes: the conversion table 6 that registers therein conversion information to perform mutual format conversion with respect to first-type data and second-type data; the first controller 1 that generates first-type data from second-type data, based on the conversion information; the second controller 2 that generates second-type data from first-type data based on the conversion information; and the third controller 7 that reads the conversion information from the conversion table 6 and notifies the first controller 1 and the second controller 2 about the read conversion information. With that, even when the first-type data has a different data format than the data format of the second-type data, the mutual format conversion with respect to the first-type data and the second-type data can be performed using the conversion table 6, the first controller 1, the second controller 2, and the third controller 7. As a result, unlike the case in which the first-type data in the first network 201 is transferred without modification as second-type data to the second network 202 or unlike the case in which the second-type data in the second network 202 is transferred without modification as first-type data to the first network 201, the data to be transferred can be converted to have the data format in accordance with the destination network. Consequently, it becomes possible to prevent the transfer of unnecessary data during the data transfer, thereby enabling achieving enhancement in the data transmission efficiency.

(Modification)

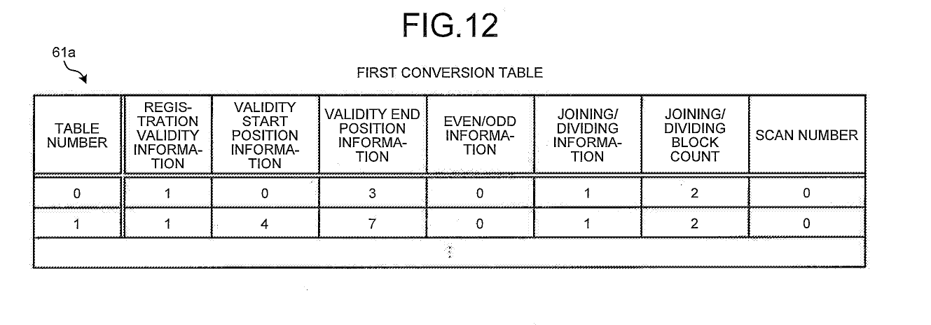

Explained below with reference to FIG. 12 to FIG. 16 is a modification. In this modification, the method of determining the bit positions of the valid data in the first-type data during a joining operation and the method of determining the bit positions of the divided data in first-type data during a dividing operation are different, than the embodiment as described above.

(Joining Operation According to Modification)

In this modification, similarly to the embodiment as described above, a joining operation includes generating second-type data of a single frame by joining the valid data included in first-type data of two frames. The joining operation according to the modification is performed based on a first conversion table 61a illustrated in FIG. 12.

In the first conversion table 61a according to the modification, unlike in the first conversion table 61 according to the embodiment as described above (see FIG. 2), the positioning of the valid data is specified not using the even/odd information but using the validity start position information and the validity end position information.

More particularly, in the first conversion table 61a illustrated in FIG. 12, as an example; in the row having the table number “0”, the validity start position information has “0” set therein, the validity end position information has “3” set therein, and the even/odd information has “0” set therein. Moreover, in the first conversion table 61a, in the row having the table number “1”, the validity start position information has “4” set therein, the validity end position information has “7” set therein, and the even/odd information has “0” set therein.

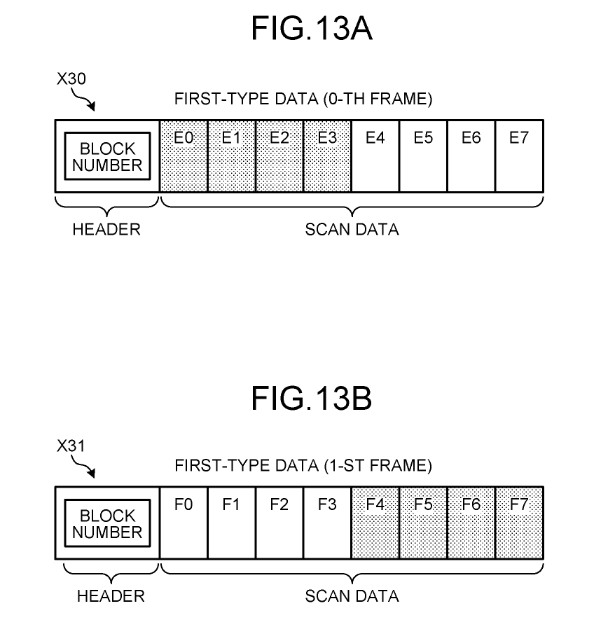

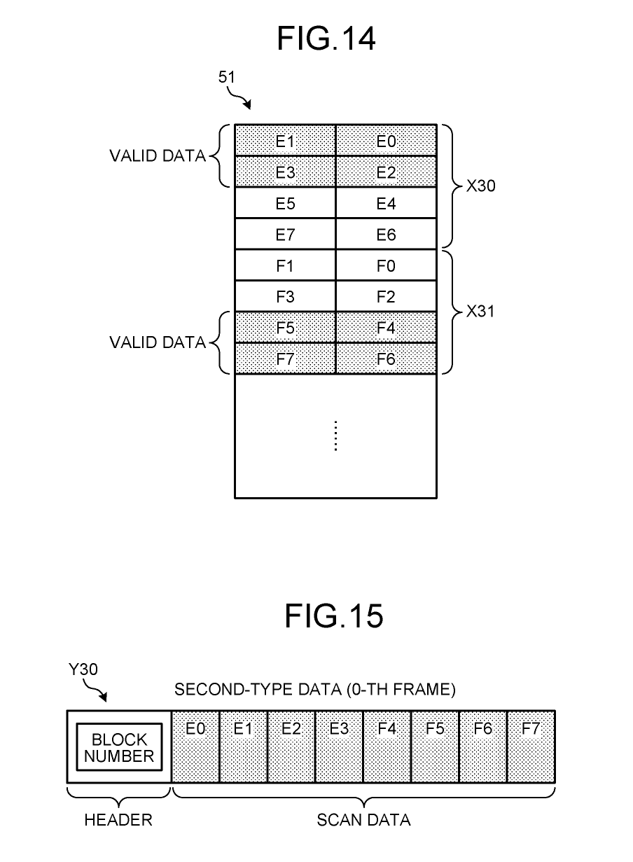

Thus, by referring to the first conversion table 61a illustrated in FIG. 12, for example, it is understood that the valid data of first-type data X30 having the block number “0” (see FIG. 13A) represents data from the 0-th bit to the 3-rd bit of the first-type data X30 (see the dotted mesh portions in FIG. 13A). Moreover, by referring to the first conversion table 61a illustrated in FIG. 12, it is understood that the valid data of first-type data X31 having the block number “1” (see FIG. 13B) represents data from the 4-th bit to the 7-th bit of the first-type data X31 (see the dotted mesh portions in FIG. 13B). Meanwhile, for example, the first-type data X30 and X31 are temporarily stored in the first area 51 of the buffer memory 50 in the state illustrated in FIG. 14.

Furthermore, in the first conversion table 61a illustrated in FIG. 12, for example, in the row having the table number “0” and the row having the table number “1”, the scan number is set to “0”. Hence, by referring to the first conversion table 61a, it is understood that the valid data of the first-type data X30 having the block number “0” (see the dotted mesh portions illustrated in FIG. 13A) and the valid data of the first-type data X31 having the block number “1” (see the dotted mesh portions illustrated in FIG. 13B) are joined, so that second-type data Y30 having the block number “0” (see FIG. 15) is generated.

(Dividing Operation According to Modification)

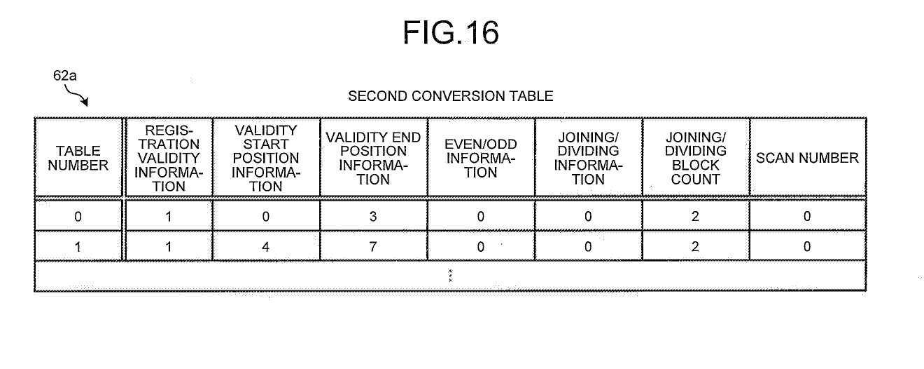

In the modification, similarly to the embodiment as described above, a dividing operation includes generating first-type data of two frames by adding predetermined additional data to each of two sets of divided data configured by dividing second-type data of a single frame. The dividing operation according to the modification is performed based on a second conversion, table 62a illustrated in FIG. 16.

The second conversion table 62a illustrated in FIG. 6 is identical to the first conversion table 61a (see FIG. 12) except for the fact that the joining/dividing information has “0” set therein. By referring to the second conversion table 62a, it is understood that the two sets of divided data configured by dividing second-type data having the block number “0” are put in the area from the 0-th bit to the 3-rd bit of the first-type data having the block number “0” and in the area from the 4-th bit to the 7-th bit of the first-type data having the block number “1”, respectively. Moreover, additional data is put in the area from the 4-th bit to the 7-th bit of the first-type data having the block number “0” and in the area from the 0-th bit to the 3-rd bit of the first-type data having the block number “1”.

While a certain embodiment of the invention has been described, the embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A gateway device that performs relaying between a first network and a second network in which cyclic transmission is performed, the gateway device comprising:
a buffer memory that temporarily stores therein first-type data transmitted in the first network and second-type data transmitted in the second network;
a conversion table that registers therein conversion information to perform mutual format conversion with respect to the first-type data and the second-type data;
a first controller that generates, based on the conversion information, the first-type data from the second-type data stored in the buffer memory;
a second controller that generates, based on the conversion information, the second-type data from the first-type data stored in the buffer memory; and
a third controller that reads the conversion information from the conversion table and notifies the first controller and the second controller about the read conversion information.

2. The gateway device according to claim 1, wherein, the second controller is configured to join, based on the conversion information, third-type data that is based on the first-type data of a Plurality of successive frames stored in the buffer memory, so that the second-type data of a single frame is generated.

3. The gateway device according to claim 2, wherein the conversion information comprises first-type information indicating number of frames to which belongs the first-type data required in generating the second-type data of a single frame.

4. The gateway device according to claim 2, wherein
the third-type data is valid data comprised in the first-type data, and
the conversion information comprises second-type information indicating bit positions in the first-type data at which the valid data is put.

5. The gateway device according to claim 1, wherein, the first controller is configured to add, based on the conversion information, predetermined additional data to a plurality of sets of fourth-type data that is configured by dividing the second-type data of a single frame stored in the buffer memory, so that the first-type data of a plurality of successive frames is generated.

6. The gateway device according to claim 5, wherein the conversion information comprises third-type information indicating number of frames to which belongs the first-type data generated based on the second-type data of a single frame.

7. The gateway device according to claim 5, wherein the conversion table comprises fourth-type information indicating bit positions in the first-type data at which the plurality of sets of fourth-type data is put,

8. The gateway device according to claim 1, wherein
the conversion table comprises fifth-type information indicating whether the format conversion needs to be performed, and
the first controller and the second controller are configured to determine whether to perform the format conversion based on the fifth-type information.

9. The gateway device according to claim 1, wherein the conversion table comprises:
a first conversion table that is referred to when performing the format conversion with respect to the first-type data; and
a second conversion table that is referred to when performing the format conversion with respect to the second-type data.
